(19) United States
(12) Patent Application Publication
(10) Pub. No.: US 2026/0094395 A1
(43) Pub. Date: Apr. 2, 2026

(54) METHOD AND DEVICE FOR RECONSTRUCTING THREE-DIMENSIONAL FACE BASED ON OCCLUSION SEGMENTATION, STORAGE MEDIUM, AND COMPUTER PROGRAM PRODUCT

(71) Applicant: BIGO TECHNOLOGY PTE. LTD., Mapletree Business City (SG)

(72) Inventors: Yejiao WANG, Beijing (CN); Yudhi Adikusuma YOHANES, Mapletree Business City (SG)

(21) Appl. No.: 19/112,801

(22) PCT Filed: Sep. 27, 2023
(86) PCT No.: PCT/CN2023/122322

§ 371 Date: Mar. 18, 2025

(30) Foreign Application Priority Data
Oct. 20, 2022 (CN) 202211286327.0

(51) Int. Cl. G06T 19/20; G06T 17/00; G06V 10/26; G06V 10/54; G06V 10/774; G06V 40/16

(52) U.S. Cl. CPC G06T 19/20; G06T 17/00; G06V 10/267; G06V 10/54; G06V 10/774; G06V 40/171; G06T 2210/22; G06T 2219/2016

(57) ABSTRACT

Provided is a method for reconstructing a three-dimensional face based on occlusion segmentation. The method includes: inputting a target face image to a preconstructed parameter prediction model, wherein the parameter prediction model includes an image feature extractor and an image segmentation decoder, and the parameter prediction model is trained based on a plurality of face training images, face key point information from the plurality of face training images, and a face occlusion segmentation region, until an association loss function between the image feature extractor and the image segmentation decoder reaches a predetermined state; and outputting a target face reconstruction parameter and a target face occlusion region of the target face image based on the parameter prediction model, and performing three-dimensional face reconstruction post-processing based on the target face reconstruction parameter and the target face occlusion region.

The present disclosure claims priority to Chinese Patent Application No. 202211286327.0, filed on Oct. 20, 2022, the disclosure of which is herein incorporated by reference in its entirety.

### TECHNICAL FIELD

Embodiments of the present disclosure relate to the technical field of computer technologies, in particular, relate to a method and system for reconstructing a three-dimensional face based on occlusion segmentation.

### BACKGROUND

Currently, three-dimensional face reconstruction technologies have been widely used in fields, such as film and television, gaming, healthcare, and social live streaming. For example, in the social live streaming field, three-dimensional (3D) (expression and texture) information of a face of a user is restored using the three-dimensional face reconstruction technology by acquiring two-dimensional (2D) face images of the user, such that functions, for example, 3D beauty and 3D makeup, are achieved. The 2D face image of the user does not always contain a complete face as expected and may be occluded by a limb or an object in practical application scenarios, and thus face occlusion segmentation is required to position a face occluded region. After three-dimensional face reconstruction, post-processing is performed based on a three-dimensional face reconstruction result and a face occlusion segmentation result to ensure an effect of face 3D beauty, 3D makeup and other functions.

However, in a three-dimensional face reconstruction application scenario in some practices, a three-dimensional face reconstruction model and a face occlusion segmentation model are independently deployed, and 3D face reconstruction and occlusion region segmentation are two independent tasks. Due to the limited computing power of the deployment platform, excessive computing resources are occupied in deploying a plurality of models, the computing workload of the platform is increased, and running of computing services on the platform is affected.

### SUMMARY

Embodiments of the present disclosure provide a method and system for reconstructing a three-dimensional face based on occlusion segmentation, which can reduce occupation of computing resources by model deployment in the three-dimensional face reconstruction application scenario of, compress the calculation amount of the model, and solve the technical problem of excessive computing resources occupation in the three-dimensional face reconstruction application scenario.

In a first aspect, the embodiments of the present disclosure provide a method for reconstructing a three-dimensional face based on occlusion segmentation. The method includes:
inputting a target face image to a preconstructed parameter prediction model, wherein the parameter prediction model includes an image feature extractor and an image segmentation decoder, and the parameter prediction model is trained based on a plurality of face training images, face key point information from the plurality of face training images, and a face occlusion segmentation region, until an association loss function between the image feature extractor and the image segmentation decoder reaches a predetermined state; and
outputting a target face reconstruction parameter and a target face occlusion region of the target face image based on the parameter prediction model, and performing three-dimensional face reconstruction post-processing based on the target face reconstruction parameter and the target face occlusion region.

In a second aspect, the embodiments of the present disclosure provide a system for reconstructing a three-dimensional face based on occlusion segmentation. The system includes:
an inputting module, configured to input a target face image to a preconstructed parameter prediction model, wherein the parameter prediction model includes an image feature extractor and an image segmentation decoder, and the parameter prediction model is trained based on a plurality of face training images, face key point information from the plurality of face training images, and a face occlusion segmentation region, until an association loss function between the image feature extractor and the image segmentation decoder reaches a predetermined state; and
an outputting module, configured to output a target face reconstruction parameter and a target face occlusion region of the target face image based on the parameter prediction model, and performing three-dimensional face reconstruction post-processing based on the target face reconstruction parameter and the target face occlusion region.

In a third aspect, the embodiments of the present disclosure provide a device for reconstructing a three-dimensional face based on occlusion segmentation. The device includes:
a memory and one or more processors; wherein
the memory is configured to store one or more programs, and
the one or more processors, when loading and running the one or more programs, are caused to perform the method for reconstructing the three-dimensional face based on the occlusion segmentation according to the first aspect.

In a fourth aspect, the embodiments of the present disclosure provide a computer-readable storage medium storing one or more computer-executable instructions. The one or more computer-executable instructions, when loaded and executed by a processor of a computer, cause the processor of the computer to perform the method for reconstructing the three-dimensional face based on the occlusion segmentation according to in the first aspect.

In a fifth aspect, the embodiments of the present disclosure provide a computer program product. The computer program product includes one or more instructions, wherein a computer or a processor, when loading and executing the one or more instructions, is caused to perform the method for reconstructing the three-dimensional face based on the occlusion segmentation according to in the first aspect.

According to the embodiments of the present disclosure, the target face image is input to the preconstructed parameter prediction model. The parameter prediction model includes the image feature extractor and the image segmentation decoder, and the parameter prediction model is trained based on the plurality of face training images, the face key point information from the plurality of face training images, and the face occlusion segmentation region, until the association loss function between the image feature extractor and the image segmentation decoder reaches the predetermined state. The target face reconstruction parameter and the target face occlusion region of the target face image are output based on the parameter prediction model, and the three-dimensional face reconstruction post-processing is performed based on the target face reconstruction parameter and the target face occlusion region. Based on the technical means, the parameter prediction model including the image feature extractor and the image segmentation decoder is trained until the association loss function between the image feature extractor and the image segmentation decoder reaches the predetermined state, such that the parameter prediction model integrates functions of the three-dimensional face reconstruction and face occlusion segmentation. Thus, the occupation of computing resources by model deployment and the redundancy of the model are reduced, the calculation amount of the model is compressed, and the efficiency of three-dimensional face reconstruction is improved.

In addition, in the embodiments of the present disclosure, the parameter dimensionality of the target face reconstruction parameter and the number of paths of the image segmentation decoder are customized, and thus the calculation amount of the parameter prediction model is adaptably configured, such that the parameter prediction model adapts the deployment environments supported by different computing powers.

### BRIEF DESCRIPTION OF THE DRAWINGS

FIG. 1 is a flowchart of a method for reconstructing a three-dimensional face based on occlusion segmentation according to some embodiments of the present disclosure;

FIG. 2 is a flowchart of training a parameter prediction model according to some embodiments of the present disclosure;

FIG. 3 is a schematic diagram of input and output of a sample of a parameter prediction model according to some embodiments of the present disclosure;

FIG. 4 is a flowchart of image preprocessing according to some embodiments of the present disclosure;

FIG. 5 is a flowchart of prediction by a parameter prediction model according to some embodiments of the present disclosure;

FIG. 6 is a flowchart of processing a target face image according to some embodiments of the present disclosure;

FIG. 7 is a schematic structural diagram of a system for reconstructing a three-dimensional face based on occlusion segmentation according to some embodiments of the present disclosure; and

FIG. 8 is a schematic structural diagram of a device for reconstructing a three-dimensional face based on occlusion segmentation according to some embodiments of the present disclosure.

### DETAILED DESCRIPTION

For clearer descriptions of the objectives, technical solutions, and advantages of the present disclosure, specific embodiments of the present disclosure are further described in detail hereinafter in conjunction with the accompanying drawings. It should be understood that the specific embodiments described herein are merely used to explain the present disclosure and are not intend to limit the present disclosure. In addition, it shall be noted that for convenience of description, only the portions associated with the present disclosure, rather than the entire content, are shown in the accompanying drawings. Before detailed description of exemplary embodiments, it should be noted that some exemplary embodiments are described as processes or methods depicted as flowcharts. Although the flowchart describes operations (or steps) in sequence, many of the operations may be performed in parallel, concurrently, or simultaneously. In addition, the sequence of the operations may be rearranged. The process may be terminated when t operations are completed, but may include additional steps that are not included in the accompanying drawings. The process may correspond to a method, a function, a procedure, a subroutine, a subprogram, and the like.

The method for reconstructing the three-dimensional face based on the occlusion segmentation according to the embodiments of the present disclosure aims to integrating the functions of the three-dimensional face reconstruction and face occlusion region segmentation in the parameter prediction model by training the parameter prediction model including the image feature extractor and the image segmentation decoder, such that the occupation of computing resources by model deployment is reduced, and the calculation amount of the model is compressed. For the traditional three-dimensional face reconstruction scenarios, in the three-dimensional face reconstruction process, an independent face occlusion segmentation model is deployed to predict a face occlusion region to avoid an effect of face occlusion on the post-processing function of the three-dimensional face, and then the three-dimensional face post-processing is performed based on the positioned occlusion region. As the three-dimensional face reconstruction model and the face occlusion segmentation model are independently deployed, and the redundant image processing processes are present between the three-dimensional face reconstruction model and the face occlusion segmentation model, the calculation pressure on the platform is increased and the operation of other platform services are affected in the case that the three-dimensional face reconstruction and the occlusion region segmentation are determined as two separate tasks. On this basis, the three-dimensional face reconstruction and the occlusion region segmentation are determined as two separate tasks in the embodiments of the present disclosure to solve the technical problem of excessive occupation of computing resources in the three-dimensional face reconstruction application scenario.

### EMBODIMENTS

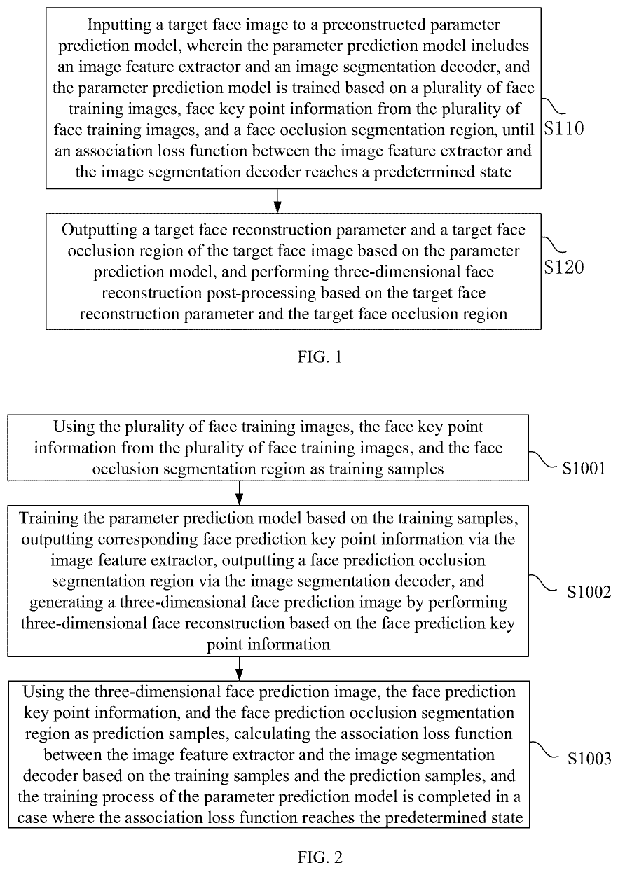

FIG. 1 is a flowchart of a method for reconstructing a three-dimensional face based on occlusion segmentation according to some embodiments of the present disclosure. The method for reconstructing the three-dimensional face based on the occlusion segmentation in the embodiments is applicable to a device for reconstructing the three-dimensional face based on occlusion segmentation, and the device for reconstructing the three-dimensional face based on the occlusion segmentation is practiced by software and/or hardware, and is composed of two or more physical entities or one physical entity. In general, the device for reconstructing the three-dimensional face based on the occlusion segmentation is a computer, a mobile phone, a tablet, an image processing server, and other processing devices.

The following embodiments are illustrated using an example where the device for reconstructing the three-dimensional face based on the occlusion segmentation performs the method for reconstructing the three-dimensional face based on the occlusion segmentation. Referring to FIG. 1, the method for reconstructing the three-dimensional face based on the occlusion segmentation includes the following processes.

In S110, a target face image is input to a preconstructed parameter prediction model, wherein the parameter prediction model includes an image feature extractor and an image segmentation decoder, and the parameter prediction model is trained based on a plurality of face training images, face key point information from the plurality of face training images, and a face occlusion segmentation region, until an association loss function between the image feature extractor and the image segmentation decoder reaches a predetermined state.

In the embodiments of the present disclosure, in the three-dimensional face reconstruction, a 2D face image that prepares to be used for the three-dimensional face image is input to the preconstructed parameter prediction model and is defined as the target face image, the parameter prediction model predicts the three-dimensional face reconstruction parameter and the face occlusion region of the target face image, and the three-dimensional face reconstruction parameter and the face occlusion region are defined as the target face reconstruction parameter and the target face occlusion region. The parameter prediction model integrates the image feature extractor and the image segmentation decoder and is trained based on the association loss function between the image feature extractor and the image segmentation decoder, such that the three-dimensional face reconstruction and the occlusion region segmentation are achieved in parallel, the processing efficiency of the model is improved, and the effects promote each other.

Prior to the above process, the parameter prediction model is pretrained so that the parameter prediction model performs the three-dimensional face reconstruction and the occlusion region segmentation. As shown in FIG. 2, the training process of the parameter prediction model includes the following processes.

In S1001, the plurality of face training images, the face key point information from the plurality of face training images, and the face occlusion segmentation region are used as training samples.

In S1002, the parameter prediction model is trained based on the training samples, corresponding face prediction key point information is output via the image feature extractor, a face prediction occlusion segmentation region is output via the image segmentation decoder, and a three-dimensional face prediction image is generated by performing three-dimensional face reconstruction based on the face prediction key point information.

In S1003, the three-dimensional face prediction image, the face prediction key point information, and the face prediction occlusion segmentation region are used as prediction samples, the association loss function between the image feature extractor and the image segmentation decoder is calculated based on the training samples and the prediction samples, and the training process of the parameter prediction model is completed in the case where the association loss function reaches the predetermined state.

In the embodiments of the present disclosure, in training the parameter prediction model, a plurality of face images are input and used as face training images, the face key point information from the plurality of face training images are acquired, and the face occlusion segmentation region of the face training image is determined based on a pretrained face region segmentation model. The image feature extractor and the image segmentation decoder of the parameter prediction model are trained based on the plurality of face training images, the face key point information from the plurality of face training images, and the face occlusion segmentation region.

The plurality of face training images are input to the image feature extractor, and then the corresponding face prediction key point information is output. Then, the face prediction key point information is input to the three-dimensional face reconstruction model for three-dimensional face reconstruction, a three-dimensional face model is determined based on the face prediction key point information, and the three-dimensional face reconstruction model is projected to a 2D plane based on a differentiable renderer and rendered as a 2D image, such that a corresponding prediction rendering image is acquired, that is, the three-dimensional face prediction image. In addition, after the image feature extractor extracts image features based on the face training image, the image features are input to the image segmentation decoder for face image segmentation, and the face prediction occlusion segmentation region is output. The parametric prediction model uses the three-dimensional face prediction image, the face prediction key point information, and the face prediction occlusion segmentation region as the prediction samples, and then the association loss function between the image feature extractor and the image segmentation decoder is calculated based on the training samples and the prediction samples. When the association loss function reaches the predetermined state, the training of the parameter prediction model is completed.

It should be noted that for the face training images in the training sample, the face region on the image includes or does not include the face occlusion region. The parameter prediction model is trained for the face training images with different occlusion conditions, such that the stability and reliability of the model prediction are improved.

In the embodiments of the present disclosure, the association loss function is designed to cause the prediction sample gradually approximate to the training sample. In the case that the association loss function is in the predetermined state, the similarity between the training sample and the prediction sample meets a model prediction standard, and the training sample is appliable to the three-dimensional face reconstruction.

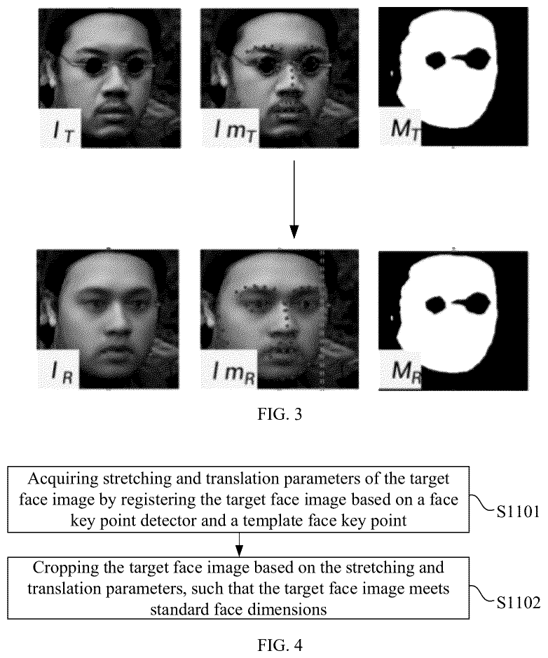

Illustratively, as shown in FIG. 3, the face training image IT, the face key point information ImT and the face occlusion segmentation region MT of the face training image are input, and the corresponding three-dimensional face prediction image IR, the face prediction key point information ImR, and the face prediction occlusion segmentation region MR are output based on the model training process. It should be noted that the three-dimensional face prediction image IR output by the parameter prediction model only reconstructs the unoccluded part of the face, and does not reconstruct the corresponding occluding object for the occluded scenario. As shown in FIG. 3, the predicted three-dimensional face prediction image IR does not reconstruct the eye occluding object sunglasses. In this way, the interference of the face occlusion region to the reconstructed three-dimensional face is avoided, and the subsequent post-processing effect of three-dimensional face reconstruction is optimized.

In some embodiments, the association loss function of the parameter prediction model includes a segmentation loss function, a segmentation scaling loss function, and a face reconstruction loss function. The segmentation loss function is configured to measure a difference between the face occlusion segmentation region and a face prediction occlusion segmentation region corresponding to the face occlusion segmentation region, the segmentation scaling loss function is configured to scale the face prediction occlusion segmentation region, and the face reconstruction loss is configured to measure a difference between each of the plurality of face training images and a three-dimensional face prediction image corresponding to the face training image.

In the embodiments of the present disclosure, the relevant loss function of face region segmentation is combined with the relevant loss function of face reconstruction, and the segmentation scaling loss function is introduced to establish the relationship between the three-dimensional face reconstruction and the face occlusion segmentation. In the case of occlusion, prediction of the face reconstruction parameter is more stable, and face occlusion segmentation is more accurate, such that the image feature extractor and the image segmentation decoder are mutually promoted to complete the model training.

In addition, the segmentation scaling loss function includes a segmentation region scale-up function and a segmentation region scale-down function. The segmentation region scale-up function is configured to scale up the face prediction occlusion segmentation region, and the segmentation region scale-down function is configured to scale down the face prediction occlusion segmentation region.

Specifically, the segmentation loss function is represented by:

$${L}_{seg} = cross\_entropy ( {M}_{R} , {M}_{T} ) ; \qquad ( 1 )$$

$$and$$

$$cross\_entropy ( p , q ) = {\sum }_{i} {p}_{i} \cdot ln \frac{1}{{q}_{i}} = - {\sum }_{i} {p}_{i} ln {q}_{i} . \qquad ( 2 )$$

the segmentation scaling loss function is represented by:

$${L}_{per \_ ori} = cos ( F ( {I}_{T} ⊙ {M}_{R} ) , F ( {I}_{T} ) ) ; \qquad ( 3 )$$

$${L}_{area} = {S}_{m} / {S}_{T} ; \qquad ( 4 )$$

$${L}_{neighbor} = {\sum }_{x ∈ Ω} {‖ {min}_{∀ {x}^{′} ∈ N ( x )} ( {I}_{T} ( x ) - {I}_{R} ( {x}^{′} ) ) ‖}_{2}^{2} ; \qquad ( 5 )$$

$$and$$

$${L}_{per \_ dist} = cos ( F ( {I}_{T} ⊙ {M}_{R} ) , F ( {I}_{R} ⊙ {M}_{R} ) ) . \qquad ( 6 )$$

L_{seg} represents the segmentation loss function, MT represents the face occlusion segmentation region, M_{R} Represents the face prediction occlusion segmentation region, and the difference between the face occlusion segmentation region and the corresponding face prediction occlusion segmentation region is represented by the segmentation loss function. I_{T} represents the face training image, I_{R} represents the three-dimensional face prediction image, S_{M} represents the number of pixels in the face occlusion segmentation region, S_{T} represents the number of pixels in the face prediction occlusion segmentation region, and x represents the pixel value. The formula (3) and the formula (4) represent the segmentation region scale-up function, which utilizes the feature that whether the image is occluded does not affect the perceptual characteristics, and maximizes the ratio between the number of pixels in the face occlusion segmentation region and the face prediction occlusion segmentation region, such that the predicted face prediction occlusion segmentation region tends to expanding as far as possible. The formula (5) and the formula (6) represent the segmentation region scale-down function. The formula (5) represents that a slight displacement error is allowed between the face training image I_{T} and the three-dimensional face prediction image I_{R} when comparing the pixel difference. The formula (6) represents that the perception error between the face training image I_{T} and the rendered image of the three-dimensional face prediction image should be as close as possible under the face prediction occlusion segmentation region. The formula (5) and the formula (6) tend to make the face prediction occlusion segmentation region ignores the parts with large errors at pixel level and perception layer, such that the predicted face prediction occlusion segmentation region tends to scaling down as much as possible.

In conjunction with formula (1) to the formula (6), the cross-entropy loss is used to ensure a basic contour of the face prediction occlusion segmentation region and fine adjustment of the face prediction occlusion segmentation region by the segmentation scaling loss function. In addition, the segmentation scaling loss function and the face reconstruction part establish association, and the errors at the perception layer and pixel level of the face are reconstructed under the condition that the predicted face prediction occlusion segmentation region is applied, such that the three-dimensional face reconstruction and face occlusion segmentation are achieved in parallel, and the effects of the three-dimensional face reconstruction and face occlusion segmentation promote each other.

In addition, the face reconstruction loss function is represented by:

$${L}_{recon \_ photo} ( x ) = {‖ ( {I}_{T} - {I}_{R} ) ⊙ {M}_{R} ‖}_{2}^{2} ; \qquad ( 7 )$$

$${L}_{landmark} ( x ) = {‖ {lm}_{T} - {lm}_{R} ‖}_{2}^{2} ; \qquad ( 8 )$$

$$and$$

$${L}_{recon \_ per} ( x ) = cos ( F ( {I}_{T} ) , F ( {I}_{R} ) ) . \qquad ( 9 )$$

The formula (7) represents that the face training image I_{T} and the three-dimensional face prediction image I_{R} are similar in pixel level in the unoccluded part. The formula (8) represents that the face key point information Im_{T} and the face prediction key point information Im_{R} should be fitted as much as possible. The formula (9) represents that the face training image I_{T} and the three-dimensional face prediction image I_{R} should be similar for model perception.

The parameter prediction model is trained based on the association loss function between the image feature extractor and the image segmentation decoder until the association loss function reaches the predetermined state, for example, the association loss function formulas (1) to (9) converges to the set value, which means that training of the parameter prediction model is completed, and a prediction result of the parameter prediction model meets an expected standard.

In the embodiments of the present disclosure, the overhead of model deployment is reduced by coupling the three-dimensional face reconstruction and face segmentation and achieving the simultaneous output of the three-dimensional face reconstruction parameter and the face occlusion region in one model. In addition, by combining three types of loss functions, that is, the segmentation loss function, the segmentation scaling loss function, and the face reconstruction loss function, the model learns the internal relationship between the three-dimensional face reconstruction and the face occlusion segmentation, such that the redundancy of the model is eliminated greatly, and a smaller model is used to achieve the three-dimensional face reconstruction and the face occlusion segmentation. In this way, the calculation amount of the model is compressed, and the processing efficiency of the model is improved.

In some embodiments of the present disclosure, based on the constructed parameter prediction model, the target face image is preprocessed in the three-dimensional face reconstruction and the face occlusion segmentation of the target face image, and the preprocessed target face image is input to the parameter prediction model for the three-dimensional face reconstruction and the face occlusion segmentation.

Referring to FIG. 4, the preprocessing process of the target face image includes the following processes.

In S1101, stretching and translation parameters of the target face image is acquired by registering the target face image based on a face key point detector and a template face key point.

In S1102, the target face image is cropped based on the stretching and translation parameters, such that the target face image meets standard face dimensions.

The preprocessing of the target face image mainly includes screening and correcting image data input to the parameter prediction model. The stretching and translation parameters of the preprocessed target face image are acquired by registering the target face image based on the face key point detector and the template face key point. Then the target face image is processed and cropped with the corresponding parameter to make the target face image conform to the standard face dimensions to facilitate use of the subsequent parameter prediction model. It should be understood that different target face images have different face regions, and the face part of the target face image should be adjusted to the standard face dimensions to ensure that the prediction effect of the parameter prediction model is standardized processing of the target face image by the parameter prediction model.

Then, for the preprocessed target face image, parameter prediction is performed based on the pretrained parameter prediction model.

In S120, a target face reconstruction parameter and a target face occlusion region of the target face image are output based on the parameter prediction model, and three-dimensional face reconstruction post-processing is performed based on the target face reconstruction parameter and the target face occlusion region.

In the embodiments of the present disclosure, the parameter prediction model receives the preprocessed target face image and determines the preprocessed target face image as input, and simultaneously outputs the corresponding target face reconstruction parameter and the target face occlusion region by model prediction.

Specifically, in the parameter prediction model, the corresponding feature map is acquired by inputting the target face image to the image feature extractor, the feature map is integrated to acquire the target face reconstruction parameter and input to the image segmentation decoder. Based on the image segmentation decoder, the image segmentation is performed to acquire the target face occlusion region.

A whole frame of the parameter prediction model is shown in FIG. 5. In the embodiments of the present disclosure, the improved lightweight mobilenet-v3 network is used as an image-level feature extractor to learn the complete three-dimensional facial structure geometry from the image pixel and facilitate deployment on the mobile device. In this case, in the embodiments of the present disclosure, a lightweight image segmentation decoder LR-ASPP is connected to the image-level feature extractor, such that the image-level feature extractor efficiently extracts deep features and detail information to achieve efficient image segmentation. FIG. 5 shows the detailed structure of the parameter prediction model according to the embodiments of the present disclosure. The parameter prediction model acquires a series of yellow feature maps by taking the preprocessed target face image as input and passing through a series of bneck blocks, and then output the parameter prediction vector, that is, the target face reconstruction parameter, based on features eventually integrated and extracted through lxi convolution.

The core component of the image-level feature extractor is the bneck module, which mainly realizes path separable convolution, a SE path attention mechanism, and residual connection. The path separable convolution enables the model to acquire a better feature extraction result using fewer parameters. The SE path attention mechanism is used to adjust the weight of each path. The residual connection contributes to combination between the model and the high and low level features, such that a foundation for the model to learn the three-dimensional face parameter is achieved.

It should be noted that in the embodiments of the present disclosure, the image-level feature extractor that can capture the three-dimensional facial feature is connected to the image segmentation decoder LR-ASPP that performs the face segmentation, such that the target face reconstruction parameter and the target face occlusion segmentation region are simultaneously output. The image segmentation decoder LR-ASPP takes 56×56 and 7×7 feature maps as the input, and performs further feature recalibration using the SE path attention mechanism for the high-level feature map (7×7). Then, the high and low resolution features are classified using the 1×1 convolution and mixed. Based on multi-level mixed feature learning, accurate segmentation of the mobile image is achieved. Ultimately, the target face occlusion segmentation region is acquired.

In some embodiments, the parameter dimensionality of the target face reconstruction parameter output by the image feature extractor and the number of paths of the image segmentation decoder correspond to a model computing power configuration of the parameter prediction model. The dimension of the target face reconstruction parameter eventually output in the embodiments of the present disclosure is randomly defined by the user, and is randomly specified by the user in combination with the required model size and effect in the training stage. The eventually output dimension is equal to a sum of identity (face ID), expression (face expression), albedo (face texture), illumination (27 dimensions), pose (3 dimensions), and translation (3 dimensions).

In addition, the calculation amount of the model structure is controlled by a width parameter, and the parameter can control the number of paths of the entire model. According to the actual calculation, the whole model can be compressed to 20 MFLOPS in the case that the width is equal to 0.5, and a great effect is acquired in the face reconstruction and the occlusion region segmentation on the evaluation set, such that the model can be deployed on various low-end devices and meet the module requirements of different computing power configurations. In conjunction with the parameter dimensionality of identity (face ID), expression (face expression), and albedo (face texture) to be acquired in the actual application scenario and the deployment environment and the calculation amount for eventually controlling the model by the width parameter, a customized model that meets the actual requirement is generated, and the flexibility of model design is improved.

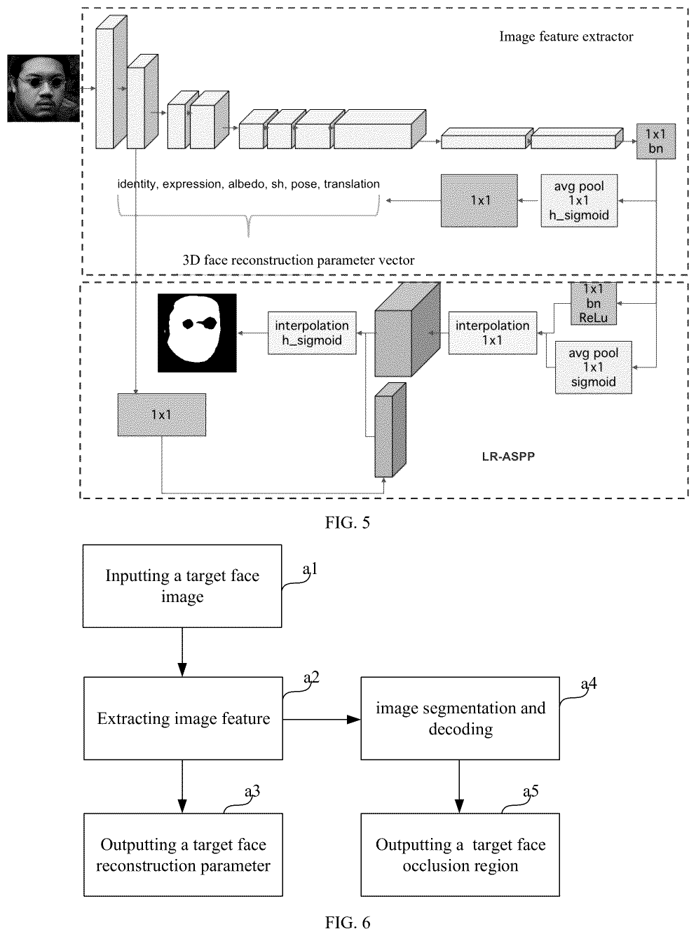

Referring to Sa1 to Sa5 in FIG. 6, based on the parameter prediction model, the preprocessed target face image is input to the parameter prediction model, and the image feature is acquired by the image feature extractor of the parameter prediction model. The image feature is used to generate the target face reconstruction parameter, and is further input to the image segmentation decoder to generate the target face occlusion region. Then, the target face reconstruction parameter and the target face occlusion region are output for the three-dimensional face reconstruction post-processing to complete the parameter prediction.

In some embodiments of the present disclosure, in the three-dimensional face reconstruction post-processing, the three-dimensional face reconstruction is performed based on the target face reconstruction parameter to generate the target three-dimensional face model. The target three-dimensional face model includes the target three-dimensional face shape and the target three-dimensional face texture. Based on the target face occlusion region, the occluded region on the target three-dimensional face model is rendered using the target face image, and the unoccluded region on the target three-dimensional face model is rendered using the target material.

Based on the target face reconstruction parameter, the three-dimensional face shape and the three-dimensional face texture are reconstructed in conjunction with the pre-generated face model base to generate the target three-dimensional face model.

The constructed formula of the target three-dimensional face model is:

$$\begin{matrix}S = S ( α , β ) = \overline{B} + {B}_{id} α + {B}_{exp} β ; and \\ T = T ( δ ) = \overline{T} + {B}_{t} δ .\end{matrix}$$

S represents the three-dimensional face shape, T represents the three-dimensional face texture, B̅ represents the average face shape, T̅ represents the average face texture, B_{id}, Bₑₓₚ, and Bₜ represent the face ID, the face expression, and the PCA base of the face texture respectively, α, β and δ represent corresponding coefficient vectors for generating the three-dimensional face model respectively. The coefficient vectors are acquired from the target face reconstruction parameter predicted by the parameter prediction model.

Other parameters output by the parameter prediction model, for example, a pose parameter and a translation parameter, are used to correct the pose of the reconstructed three-dimensional face model. An illumination parameter is used to perform spherical harmonic illumination on the reconstructed face texture to make the result more vivid and detailed.

It should be noted that the three-dimensional face reconstruction post-processing of the embodiments of the present disclosure is described using an example of the three-dimensional makeup in the live streaming. In the live streaming 3D makeup, the three-dimensional face model reconstructed based on the user face image is fitted with 3D makeup materials, and then the eventual rendering texture is calculated based on the target face occlusion region predicted by the parameter prediction model. The occluded region is rendered using an original image (and the target face image) collected by the camera, and the unoccluded region is rendered using the 3D makeup material according to normal logic, such that a purpose that the occluded region is rendered using the original image collected by the camera and the unoccluded region is rendered using the reconstruction 3D makeup is achieved. Thus, the user enjoys the beautiful visual effect of makeup, the beauty effect only on the surface of the occlusion is avoided, and the 3D beauty effect is optimized.

In actual application scenarios, the method for reconstructing the three-dimensional face according to the embodiments of the present disclosure is also applicable to any three-dimensional face reconstruction application scenario that requires real-time processing of possible occlusion input, for example, live streaming, and 3D beauty makeup, 3D special effects, medical plastic modeling, and the like in meeting scenarios. The embodiments of the present disclosure have fixed limitations on specific application environment processes, which are not repeated herein.

The target face image is input to the preconstructed parameter prediction model. The parameter prediction model includes the image feature extractor and the image segmentation decoder, and the parameter prediction model is trained based on the plurality of face training images, the face key point information from the plurality of face training images, and the face occlusion segmentation region, until the association loss function between the image feature extractor and the image segmentation decoder reaches the predetermined state. The target face reconstruction parameter and the target face occlusion region of the target face image are output based on the parameter prediction model, and the three-dimensional face reconstruction post-processing is performed based on the target face reconstruction parameter and the target face occlusion region. Based on the technical means, the parameter prediction model including the image feature extractor and the image segmentation decoder is trained until the association loss function between the image feature extractor and the image segmentation decoder reaches the predetermined state, such that the parameter prediction model integrates functions of the three-dimensional face reconstruction and face occlusion segmentation. Thus, the occupation of computing resources by model deployment and the redundancy of the model are reduced, the calculation amount of the model is compressed, and the efficiency of three-dimensional face reconstruction is improved.

In addition, in the embodiments of the present disclosure, the parameter dimensionality of the target face reconstruction parameter and the number of paths of the image segmentation decoder are customized, and thus the calculation amount of the parameter prediction model is adaptably configured, such that the parameter prediction model adapts the deployment environments supported by different computing powers.

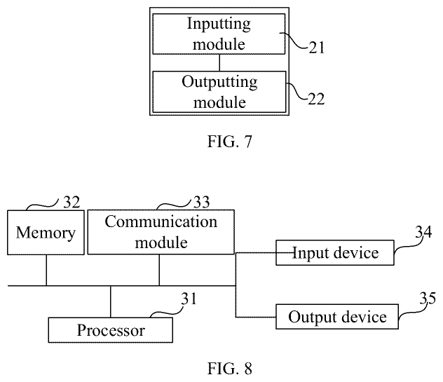

On the basis of above embodiments, FIG. 7 is a schematic structural diagram of a system for reconstructing a three-dimensional face based on occlusion segmentation according to some embodiments of the present disclosure. Referring to FIG. 7, the system for reconstructing the three-dimensional face based on the occlusion segmentation includes an input module and an output module.

The input module 21 is configured to input a target face image to a preconstructed parameter prediction model, wherein the parameter prediction model includes an image feature extractor and an image segmentation decoder, and the parameter prediction model is trained based on a plurality of face training images, face key point information from the plurality of face training images, and a face occlusion segmentation region, until an association loss function between the image feature extractor and the image segmentation decoder reaches a predetermined state.

The output module 22 is configured to output a target face reconstruction parameter and a target face occlusion region of the target face image based on the parameter prediction model, and perform three-dimensional face reconstruction post-processing based on the target face reconstruction parameter and the target face occlusion region.

A training process of the parameter prediction model includes:
using the plurality of face training images, the face key point information from the plurality of face training images, and the face occlusion segmentation region as training samples;
training the parameter prediction model based on the training samples, outputting corresponding face prediction key point information via the image feature extractor, outputting a face prediction occlusion segmentation region via the image segmentation decoder, and generating a three-dimensional face prediction image by performing three-dimensional face reconstruction based on the face prediction key point information; and
using the three-dimensional face prediction image, the face prediction key point information, and the face prediction occlusion segmentation region as prediction samples, calculating the association loss function between the image feature extractor and the image segmentation decoder based on the training samples and the prediction samples, and the training process of the parameter prediction model is completed in a case where the association loss function reaches the predetermined state.

The association loss function includes a segmentation loss function, a segmentation scaling loss function, and a face reconstruction loss function, wherein the segmentation loss function is configured to measure a difference between the face occlusion segmentation region and a face prediction occlusion segmentation region corresponding to the face occlusion segmentation region; the segmentation scaling loss function is configured to scale the face prediction occlusion segmentation region; and the face reconstruction loss is configured to measure a difference between each of the plurality of face training images and a three-dimensional face prediction image corresponding to the face training image.

The segmentation scaling loss function includes a segmentation region scale-up function and a segmentation region scale-down function, wherein the segmentation region scale-up function is configured to scale up the face prediction occlusion segmentation region, and the segmentation region scale-down function is configured to scale down the face prediction occlusion segmentation region.

The input module 21 is configured to acquire a feature image corresponding to the target face image by outputting the target face image to the image feature extractor, acquire the target face reconstruction parameter by integrating the feature image, input the feature image to the image segmentation decoder, and acquire the target face occlusion region by performing image segmentation via the image segmentation decoder.

A parameter dimensionality of the target face reconstruction parameter output by the image feature extractor and a number of paths of the image segmentation decoder correspond to a model computing power configuration of the parameter prediction model.

Prior to inputting the target face image to the preconstructed parameter prediction model, the method further includes:
acquiring stretching and translation parameters of the target face image by registering the target face image based on a face key point detector and a template face key point; and
cropping the target face image based on the stretching and translation parameters, such that the target face image meets standard face dimensions.

The output module 22 is configured to generate a target three-dimensional face model by performing three-dimensional face reconstruction based on the target face reconstruction parameter, wherein the target three-dimensional face model includes a target three-dimensional face shape and a target three-dimensional face texture; and render an occlusion region in the target three-dimensional face model based on the target face occlusion region using the target face image, and render an unocclusion region in the target three-dimensional face model using a target material.

The target face image is input to the preconstructed parameter prediction model. The parameter prediction model includes the image feature extractor and the image segmentation decoder, and the parameter prediction model is trained based on the plurality of face training images, the face key point information from the plurality of face training images, and the face occlusion segmentation region, until the association loss function between the image feature extractor and the image segmentation decoder reaches the predetermined state. The target face reconstruction parameter and the target face occlusion region of the target face image are output based on the parameter prediction model, and the three-dimensional face reconstruction post-processing is performed based on the target face reconstruction parameter and the target face occlusion region. Based on the technical means, the parameter prediction model including the image feature extractor and the image segmentation decoder is trained until the association loss function between the image feature extractor and the image segmentation decoder reaches the predetermined state, such that the parameter prediction model integrates functions of the three-dimensional face reconstruction and face occlusion segmentation. Thus, the occupation of computing resources by model deployment and the redundancy of the model are reduced, the calculation amount of the model is compressed, and the efficiency of three-dimensional face reconstruction is improved.

In addition, in the embodiments of the present disclosure, the parameter dimensionality of the target face reconstruction parameter and the number of paths of the image segmentation decoder are customized, and thus the calculation amount of the parameter prediction model is adaptably configured, such that the parameter prediction model adapts the deployment environments supported by different computing powers.

The system for reconstructing the three-dimensional face based on the occlusion segmentation is applicable to the method for reconstructing the three-dimensional face based on the occlusion segmentation in above embodiments, and has the corresponding functions and technical effects.

Based on the above embodiments, some embodiments of the present disclosure further provide a device for reconstructing the three-dimensional face based on occlusion segmentation. Referring to FIG. 8, the device for reconstructing the three-dimensional face based on the occlusion segmentation includes a processor 31, a memory 32, a communication module 33, an input device 34, and an output device 35. The memory 32, as a computer-readable storage medium, can be configured to store software programs, computer executable programs, and modules, for example, program instructions/modules (for example, the inputting module and the outputting module in the system for reconstructing the three-dimensional face) corresponding to the occlusion-segmentation-based method for reconstructing the three-dimensional face based on the occlusion segmentation in any embodiment of the present disclosure. The communication module 33 is configured for data transmission. By running the software programs, instructions, and modules stored in the memory, the processor 31 executes various functional applications and data processing of the device, that is, the method for reconstructing the three-dimensional face based on the occlusion segmentation. The input device 34 is configured to receive input numeric or character information and generate key signal input related to user settings and functional controls of the device. The output device 35 includes a display device, for example, a display screen. The device for reconstructing the three-dimensional face based on the occlusion segmentation is applicable to the method for reconstructing the three-dimensional face based on the occlusion segmentation in above embodiments, and has the corresponding functions and technical effects.

Based on the above embodiments, some embodiments of the present disclosure further provide a computer-readable storage medium storing one or more computer-executable instructions. The one or more computer-executable instructions, when loaded and executed by a processor of a computer, cause the processor of the computer to perform the method for reconstructing the three-dimensional face based on the occlusion segmentation according to above embodiments. The storage medium is any type of memory or storage device. In addition, according to the computer-readable storage medium according to the embodiments of the present disclosure, the one or more computer-executable instructions thereof are not limited to the method for reconstructing the three-dimensional face based on the occlusion segmentation provided above, but may be also used to perform related operations in the method for reconstructing the three-dimensional face based on the occlusion segmentation in any one of the embodiments of the present disclosure.

Based on the above embodiments, some embodiments of the present disclosure further provide a computer program product. The technical solutions according to the embodiments of the present disclosure, or the part contributing to the prior art, or the all or part of the technical solutions may be embodied in the form of a software product, which is stored in a storage medium and includes instructions to cause a computer device, a mobile terminal, or a processor therein to perform all or part of processes of the method for reconstructing the three-dimensional face based on the occlusion segmentation in above embodiments.

1. A method for reconstructing a three-dimensional face based on occlusion segmentation, comprising:
inputting a target face image to a preconstructed parameter prediction model, wherein the parameter prediction model comprises an image feature extractor and an image segmentation decoder, and the parameter prediction model is trained based on a plurality of face training images, face key point information from the plurality of face training images, and a face occlusion segmentation region, until an association loss function between the image feature extractor and the image segmentation decoder reaches a predetermined state; and
outputting a target face reconstruction parameter and a target face occlusion region of the target face image based on the parameter prediction model, and performing three-dimensional face reconstruction post-processing based on the target face reconstruction parameter and the target face occlusion region.

2. The method according to claim 1, wherein a training process of the parameter prediction model comprises:
using the plurality of face training images, the face key point information from the plurality of face training images, and the face occlusion segmentation region as training samples;
training the parameter prediction model based on the training samples, outputting corresponding face prediction key point information via the image feature extractor, outputting a face prediction occlusion segmentation region via the image segmentation decoder, and generating a three-dimensional face prediction image by performing three-dimensional face reconstruction based on the face prediction key point information; and
using the three-dimensional face prediction image, the face prediction key point information, and the face prediction occlusion segmentation region as prediction samples, calculating the association loss function between the image feature extractor and the image segmentation decoder based on the training samples and the prediction samples, and the training process of the parameter prediction model is completed in a case where the association loss function reaches the predetermined state.

3. The method according to claim 2, wherein the association loss function comprises a segmentation loss function, a segmentation scaling loss function, and a face reconstruction loss function; wherein
the segmentation loss function is configured to measure a difference between the face occlusion segmentation region and a face prediction occlusion segmentation region corresponding to the face occlusion segmentation region;
the segmentation scaling loss function is configured to scale the face prediction occlusion segmentation region; and
the face reconstruction loss function is configured to measure a difference between each of the plurality of face training images and a three-dimensional face prediction image corresponding to the face training image.

4. The method according to claim 3, wherein the segmentation scaling loss function comprises a segmentation region scale-up function and a segmentation region scale-down function, wherein the segmentation region scale-up function is configured to scale up the face prediction occlusion segmentation region, and the segmentation region scale-down function is configured to scale down the face prediction occlusion segmentation region.

5. The method according to claim 1, wherein outputting the target face reconstruction parameter and the target face occlusion region of the target face image based on the parameter prediction model comprises:
acquiring a feature image corresponding to the target face image by outputting the target face image to the image feature extractor, acquiring the target face reconstruction parameter by integrating the feature image, inputting the feature image to the image segmentation decoder, and acquiring the target face occlusion region by performing image segmentation via the image segmentation decoder.

6. The method according to claim 1, wherein a parameter dimensionality of the target face reconstruction parameter output by the image feature extractor and a number of paths of the image segmentation decoder correspond to a model computing power configuration of the parameter prediction model.

7. The method according to claim 1, wherein prior to inputting the target face image to the preconstructed parameter prediction model, the method further comprises:
acquiring stretching and translation parameters of the target face image by registering the target face image based on a face key point detector and a template face key point; and
cropping the target face image based on the stretching and translation parameters, such that the target face image meets standard face dimensions.

8. The method according to claim 1, wherein performing the three-dimensional face reconstruction post-processing based on the target face reconstruction parameter and the target face occlusion region comprises:
generating a target three-dimensional face model by performing three-dimensional face reconstruction based on the target face reconstruction parameter, wherein the target three-dimensional face model comprises a target three-dimensional face shape and a target three-dimensional face texture; and
rendering an occlusion region in the target three-dimensional face model based on the target face occlusion region using the target face image, and rendering an unocclusion region in the target three-dimensional face model using a target material.

9. (canceled)

10. A device for reconstructing a three-dimensional face based on occlusion segmentation, comprising: a memory and one or more processors, wherein the memory is configured to store one or more programs, and the one or more processors, when loading and running the one or more programs, are caused to:
input a target face image to a preconstructed parameter prediction model, wherein the parameter prediction model comprises an image feature extractor and an image segmentation decoder, and the parameter prediction model is trained based on a plurality of face training images, face key point information from the plurality of face training images, and a face occlusion segmentation region, until an association loss function between the image feature extractor and the image segmentation decoder reaches a predetermined state; and
output a target face reconstruction parameter and a target face occlusion region of the target face image based on the parameter prediction model, and perform three-dimensional face reconstruction post-processing based on the target face reconstruction parameter and the target face occlusion region.

11. A non-transitory computer-readable storage medium, storing one or more computer-executable instructions, wherein the one or more computer-executable instructions, when loaded and executed by a processor of a computer, cause the processor of the computer to:
input a target face image to a preconstructed parameter prediction model, wherein the parameter prediction model comprises an image feature extractor and an image segmentation decoder, and the parameter prediction model is trained based on a plurality of face training images, face key point information from the plurality of face training images, and a face occlusion segmentation region, until an association loss function between the image feature extractor and the image segmentation decoder reaches a predetermined state; and
output a target face reconstruction parameter and a target face occlusion region of the target face image based on the parameter prediction model, and perform three-dimensional face reconstruction post-processing based on the target face reconstruction parameter and the target face occlusion region.

12. A computer program product, comprising: one or more instructions, wherein a computer or a processor, when loading and executing the one or more instructions, is caused to perform the method for reconstructing the three-dimensional face based on occlusion segmentation as defined in claim 1.

13. The device according to claim 10, wherein a training process of the parameter prediction model comprises:
using the plurality of face training images, the face key point information from the plurality of face training images, and the face occlusion segmentation region as training samples;
training the parameter prediction model based on the training samples, outputting corresponding face prediction key point information via the image feature extractor, outputting a face prediction occlusion segmentation region via the image segmentation decoder, and generating a three-dimensional face prediction image by performing three-dimensional face reconstruction based on the face prediction key point information; and
using the three-dimensional face prediction image, the face prediction key point information, and the face prediction occlusion segmentation region as prediction samples, calculating the association loss function between the image feature extractor and the image segmentation decoder based on the training samples and the prediction samples, and the training process of the parameter prediction model is completed in a case where the association loss function reaches the predetermined state.

14. The device according to claim 13, wherein the association loss function comprises a segmentation loss function, a segmentation scaling loss function, and a face reconstruction loss function; wherein
the segmentation loss function is configured to measure a difference between the face occlusion segmentation region and a face prediction occlusion segmentation region corresponding to the face occlusion segmentation region;
the segmentation scaling loss function is configured to scale the face prediction occlusion segmentation region; and
the face reconstruction loss function is configured to measure a difference between each of the plurality of face training images and a three-dimensional face prediction image corresponding to the face training image.

15. The device according to claim 14, wherein the segmentation scaling loss function comprises a segmentation region scale-up function and a segmentation region scale-down function, wherein the segmentation region scale-up function is configured to scale up the face prediction occlusion segmentation region, and the segmentation region scale-down function is configured to scale down the face prediction occlusion segmentation region.

16. The device according to claim 10, wherein the one or more processors, when loading and running the one or more programs, are caused to:
acquire a feature image corresponding to the target face image by outputting the target face image to the image feature extractor, acquire the target face reconstruction parameter by integrating the feature image, input the feature image to the image segmentation decoder, and acquire the target face occlusion region by performing image segmentation via the image segmentation decoder.

17. The device according to claim 10, wherein a parameter dimensionality of the target face reconstruction parameter output by the image feature extractor and a number of paths of the image segmentation decoder correspond to a model computing power configuration of the parameter prediction model.

18. The device according to claim 10, wherein the one or more processors, when loading and running the one or more programs, are further caused to:
acquire stretching and translation parameters of the target face image by registering the target face image based on a face key point detector and a template face key point; and
crop the target face image based on the stretching and translation parameters, such that the target face image meets standard face dimensions.

19. The device according to claim 10, wherein the one or more processors, when loading and running the one or more programs, are caused to:
generate a target three-dimensional face model by performing three-dimensional face reconstruction based on the target face reconstruction parameter, wherein the target three-dimensional face model comprises a target three-dimensional face shape and a target three-dimensional face texture; and
render an occlusion region in the target three-dimensional face model based on the target face occlusion region using the target face image, and render an unocclusion region in the target three-dimensional face model using a target material.

20. The non-transitory computer-readable storage medium according to claim 11, wherein a training process of the parameter prediction model comprises:
using the plurality of face training images, the face key point information from the plurality of face training images, and the face occlusion segmentation region as training samples;
training the parameter prediction model based on the training samples, outputting corresponding face prediction key point information via the image feature extractor, outputting a face prediction occlusion segmentation region via the image segmentation decoder, and generating a three-dimensional face prediction image by performing three-dimensional face reconstruction based on the face prediction key point information; and
using the three-dimensional face prediction image, the face prediction key point information, and the face prediction occlusion segmentation region as prediction samples, calculating the association loss function between the image feature extractor and the image segmentation decoder based on the training samples and the prediction samples, and the training process of the parameter prediction model is completed in a case where the association loss function reaches the predetermined state.

21. The non-transitory computer-readable storage medium according to claim 20, wherein the association loss function comprises a segmentation loss function, a segmentation scaling loss function, and a face reconstruction loss function; wherein
the segmentation loss function is configured to measure a difference between the face occlusion segmentation region and a face prediction occlusion segmentation region corresponding to the face occlusion segmentation region;
the segmentation scaling loss function is configured to scale the face prediction occlusion segmentation region; and
the face reconstruction loss function is configured to measure a difference between each of the plurality of face training images and a three-dimensional face prediction image corresponding to the face training image.
